(19) United States
(12) Patent Application Publication
(10) Pub. No.: US 2007/0273622 A1
(43) Pub. Date: Nov. 29, 2007

(54) Amoled pixel unit

(75) Inventor: Jiunn-Yau Huang, Tainan County (TW)

Correspondence Address: RABIN & Berdo, PC, 1101 14TH STREET, NW, SUITE 500, WASHINGTON, DC, 20005, US

(73) Assignee: HIMAX TECHNOLOGIES LIMITED, Tainan County (TW)

(21) Appl. No.: 11/802,981

(22) Filed: May 29, 2007

(30) Foreign Application Priority Data
May 29, 2006 (CN) 095119047

(51) Int. Cl. G09G 3/30

(52) U.S. Cl. 345/76

(57) ABSTRACT

An AMOLED pixel unit includes an OLED, first to fourth switches, and an energy-storage element. The OLED has a cathode receiving a ground voltage. The first switch has a first terminal receiving a data signal. The second switch has a first terminal coupled to a second terminal of the first switch. Control terminals of the first and second switches receive a scan signal. The third switch has a first terminal coupled to the second terminal of the first switch, a second terminal receiving an operation voltage, and a third control terminal coupled to a second terminal of the second switch. The fourth switch has a first terminal coupled to an anode of the OLED, a second terminal receiving the operation voltage, and a fourth control terminal coupled to the third control terminal. The energy-storage element coupled to the fourth control terminal receives the operation or ground voltage.

This application claims the benefit of Taiwan application Serial No. 95119047, filed May 29, 2006, the subject matter of which is incorporated herein by reference.

### BACKGROUND OF THE INVENTION

1. Field of the Invention

The invention relates in general to an active matrix organic light emitting diode (AMOLED) pixel unit, and more particularly to an AMOLED pixel unit having four switches and one energy-storage element.

2. Description of the Related Art

FIG. 1 (Prior Art) is a circuit diagram showing a conventional AMOLED pixel unit 10. Referring to FIG. 1, the AMOLED pixel unit 10 includes a first switch T1, a second switch T2, a third switch T3, a fourth switch T4, an energy-storage element C and an organic light emitting diode (OLED) 12. The first switch T1, the second switch T2, the third switch T3 and the fourth switch T4 may be PMOS transistors, and the energy-storage element C may be a capacitor, for example.

The first switch T1 has a first terminal for receiving a data signal Data and a control terminal for receiving a first scan signal Scan1. The second switch T2 has a first terminal coupled to a second terminal of the first switch T1, a second terminal for receiving an operation voltage VDD, and a control terminal coupled to the first terminal of the second switch T2. The third switch T3 has a first terminal coupled to the control terminal of the second switch T2, and a control terminal for receiving a second scan signal Scan2. The fourth switch T4 has a first terminal coupled to an OLED 12, a second terminal coupled to the second terminal of the second switch T2, and a control terminal coupled to a second terminal of the third switch T3. The energy-storage element C has a first terminal coupled to the control terminal of the fourth switch T4, and a second terminal coupled to the second terminal of the fourth switch T4.

In a writing timing stage, the first scan signal Scan1 turns on the first switch T1 as well as the second switch T2. Thus, the second switch T2 generates a data current Idata through the turned-on first switch T1 according to the data signal Data. Meanwhile, the second scan signal Scan2 turns on the third switch T3, so the fourth switch T4 and the second switch T2 forms a current mirror circuit, and the fourth switch T4 generates a pixel current Ioled in proportional to the data current Idata, and outputs the pixel current Ioled to the OLED 12 to enable the OLED 12 to emit the corresponding luminance. In this writing timing stage, the energy-storage element C is also charged, through the turned-on third switch T3 and the turned-on first switch T1, to reach a corresponding data voltage Vdata and the energy-storage element C is stably kept at the data voltage Vdata.

In a displaying timing stage, the second scan signal Scan2 first turns off the third switch T3, and then the first scan signal Scan1 turns off the first switch T1. The second scan signal Scan2 turns off the third switch T3, so the fourth switch T4 is not electrically connected to the data signal Data. However, the fourth switch T4 still outputs the pixel current Ioled to the OLED 12 to enable the OLED 12 to emit the corresponding luminance by the energy-storage element C which is stably kept at the data voltage Vdata.

In the conventional AMOLED pixel unit 10 mentioned hereinabove, four switches T1 to T4 and one energy-storage element C are utilized to form a circuit structure for driving the OLED 12 to emit the corresponding luminance so that the structures of the organic diode pixel units are restricted to the same configuration. However, it is always insufficient if additional wires are needed to obtain the best electrical effect when the organic diode pixel display structure is being manufactured.

### SUMMARY OF THE INVENTION

The invention is directed to an AMOLED pixel unit utilizing a current mirror circuit architecture to drive an OLED to emit the corresponding luminance.

According to a first aspect of the present invention, an AMOLED pixel unit including an OLED, a first switch, a second switch, a third switch, a fourth switch and an energy-storage element is provided. The OLED has a cathode for receiving a ground voltage. The first switch has a first terminal for receiving a data signal, and a control terminal for receiving a scan signal. The second switch has a first terminal coupled to a second terminal of the first switch, and a control terminal for receiving the scan signal. The third switch has a first terminal coupled to the second terminal of the first switch, a second terminal for receiving an operation voltage, and a control terminal coupled to a second terminal of the second switch. The fourth switch has a first terminal coupled to an anode of the OLED, a second terminal for receiving the operation voltage, and a control terminal coupled to the control terminal of the third switch. The energy-storage element has a first terminal coupled to the control terminal of the fourth switch, and a second terminal for receiving the operation voltage or the ground voltage.

According to a second aspect of the present invention, an AMOLED pixel unit including an OLED, a first switch, a second switch, a third switch, a fourth switch and an energy-storage element is provided. The OLED has an anode for receiving an operation voltage. The first switch has a first terminal for receiving a data signal, and a control terminal for receiving a scan signal. The second switch has a first terminal coupled to a second terminal of the first switch, and a control terminal for receiving the scan signal. The third switch has a first terminal coupled to a second terminal of the second switch, a second terminal for receiving a ground voltage, and a control terminal coupled to the second terminal of the first switch. The fourth switch has a first terminal coupled to a cathode of the OLED, a second terminal for receiving the ground voltage, and a control terminal coupled to the second terminal of the second switch. The energy-storage element has s first terminal coupled to the control terminal of the fourth switch, and a second terminal for receiving the operation voltage or the ground voltage.

The invention will become apparent from the following detailed description of the four preferred but non-limiting embodiments. The following description is made with reference to the accompanying drawings.

### BRIEF DESCRIPTION OF THE DRAWINGS

FIG. 1 (Prior Art) is a circuit diagram showing a conventional AMOLED pixel unit.

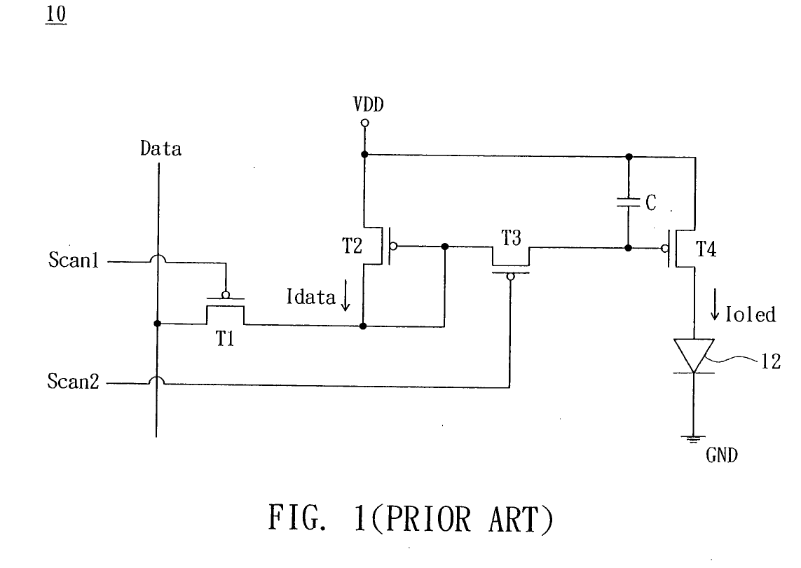

FIG. 2 is a circuit diagram showing an AMOLED pixel unit according to a first embodiment of the invention.

FIG. 3 is a circuit diagram showing an AMOLED pixel unit according to a second embodiment of the invention.

FIG. 4 is a circuit diagram showing an AMOLED pixel unit according to a third embodiment of the invention.

FIG. 5 is a circuit diagram showing an AMOLED pixel unit according to a fourth embodiment of the invention.

### DETAILED DESCRIPTION OF THE INVENTION

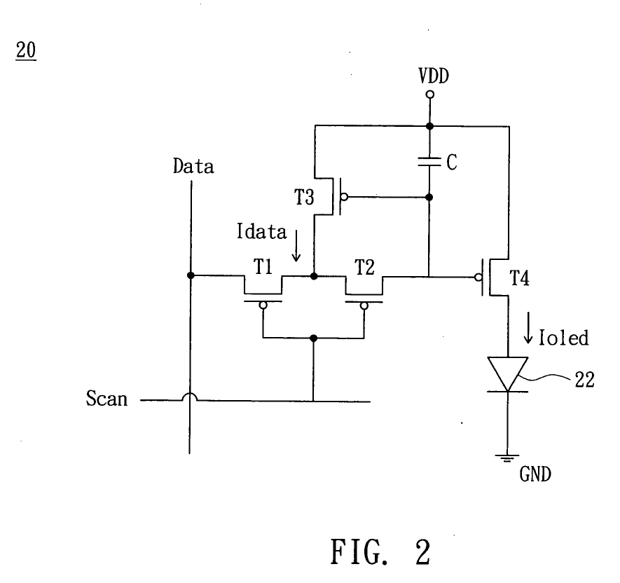

The invention provides an active matrix organic light emitting diode (AMOLED) pixel unit having a current mirror circuit architecture for driving an organic light emitting diode (OLED) to emit corresponding luminance. FIG. 2 is a circuit diagram showing an AMOLED pixel unit 20 according to a first embodiment of the invention. Referring to FIG. 2, the AMOLED pixel unit 20 includes a first switch T1, a second switch T2, a third switch T3, a fourth switch T4, an energy-storage element C and an OLED 22. The first switch T1, the second switch T2, the third switch T3 and the fourth switch T4 are PMOS transistors, and the energy-storage element C is a capacitor, for example.

The first switch T1 has a first terminal for receiving a data signal Data, and a control terminal for receiving a scan signal Scan. The second switch T2 has a first terminal coupled to a second terminal of the first switch T1, and a control terminal for receiving the scan signal Scan. The third switch T3 has a first terminal coupled to the second terminal of the first switch T1, a second terminal for receiving an operation voltage VDD, and a control terminal coupled to a second terminal of the second switch T2.

The fourth switch T4 has a first terminal coupled to an anode of the OLED 22, a second terminal for receiving an operation voltage VDD, and a control terminal coupled to the control terminal of the third switch T3. The OLED 22 also has a cathode for receiving a ground voltage GND. The energy-storage element C has a first terminal coupled to the control terminal of the fourth switch T4, and a second terminal for receiving the operation voltage VDD.

In a writing timing stage, the scan signal Scan turns on the first switch T1 and the second switch T2, and the third switch T3 is also turned on. Then, the third switch T3 generates a data current Idata through the turned-on first switch T1 according to the data signal Data. Meanwhile, because the fourth switch T4 and the third switch T3 form a current mirror circuit, the fourth switch T4 generates a pixel current Ioled in proportional to the data current Idata, and outputs the pixel current Ioled to the OLED 22 to enable the OLED 22 to emit the corresponding luminance. In this writing timing stage, the energy-storage element C is also charged through the turned-on first switch T1 and the turned-on second switch T2 to reach a corresponding data voltage Vdata and the energy-storage element C is stably kept at the data voltage Vdata.

In a displaying timing stage, the scan signal Scan turns off the first switch T1 and the second switch T2, so the third switch T3 is also turned off, and the fourth switch T4 is not electrically connected to the data signal Data again. However, because the energy-storage element C is stably kept at the data voltage Vdata, the fourth switch T4 still outputs the pixel current Ioled to the OLED 22 to make the OLED emit the corresponding luminance.

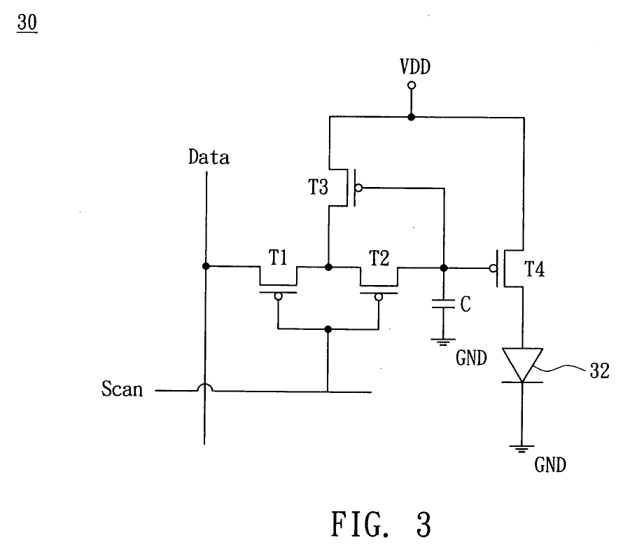

In the AMOLED pixel unit 20, the position of the energy-storage element C is not particularly limited to that for enabling the first terminal of the energy-storage element C to be coupled to the control terminal of the fourth switch T4, and the second terminal to receive the operation voltage VDD. FIG. 3 is a circuit diagram showing an AMOLED pixel unit 30 according to a second embodiment of the invention. In the AMOLED pixel unit 30, the first terminal of the energy-storage element C is coupled to the control terminal of the fourth switch T4, and the second terminal of the energy-storage element C receives the ground voltage GND. Consequently, the energy-storage element C may also be stably kept at the data voltage Vdata so that the fourth switch T4 still outputs the pixel current Ioled to the OLED 32 to enable the OLED 32 to emit the corresponding luminance. The circuit architecture and operating principle of other portions are the same as those of FIG. 2, so detailed descriptions thereof will be omitted.

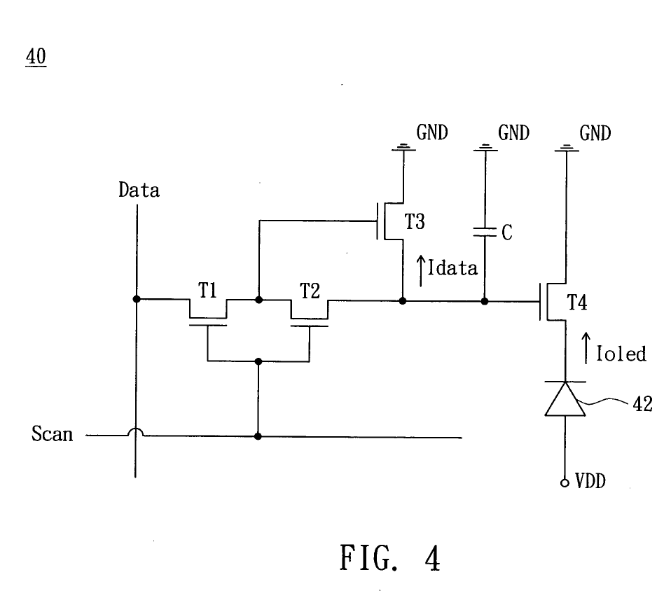

In the AMOLED pixel unit of the invention, the first switch, the second switch, the third switch and the fourth switch may also be NMOS transistors. FIG. 4 is a circuit diagram showing an AMOLED pixel unit 40 according to a third embodiment of the invention. Referring to FIG. 4, the AMOLED pixel unit 40 includes a first switch T1, a second switch T2, a third switch T3, a fourth switch T4, an energy-storage element C and an OLED 42. The first switch T1, the second switch T2, the third switch T3 and the fourth switch T4 are NMOS transistors, and the energy-storage element C is a capacitor, for example.

The OLED 42 has an anode for receiving an operation voltage VDD. The first switch T1 has a first terminal for receiving a data signal Vdata, and a control terminal for receiving a scan signal Scan. The second switch T2 has a first terminal coupled to a second terminal of the first switch T1, and a control terminal for receiving the scan signal Scan. The third switch T3 has a first terminal coupled to a second terminal of the second switch T2, a second terminal for receiving a ground voltage GND, and a control terminal coupled to the second terminal of the first switch T1.

The fourth switch T4 has a first terminal coupled to a cathode of the OLED 42, a second terminal for receiving the ground voltage GND, and a control terminal coupled to the second terminal of the second switch T2. The energy-storage element C has a first terminal coupled to the control terminal of the fourth switch T4, and a second terminal for receiving the ground voltage GND.

In a writing timing stage, the scan signal Scan turns on the first switch T1 and the second switch T2, and the third switch T3 is thus turned on. A data signal Data enables a data current Idata to be inputted to the third switch T3 through the turned-on first switch T1. Meanwhile, the fourth switch T4 and the third switch T3 form a current mirror circuit, so the fourth switch T4 generates a pixel current Ioled in proportional to the data current Idata to enable the OLED 42 to emit the corresponding luminance. In this writing timing stage, the energy-storage element C is also charged through the turned-on first switch T1 and the turned-on second switch T2 to reach a corresponding data voltage Vdata, and the energy-storage element C is stably kept at the data voltage Vdata.

In a displaying timing stage, the scan signal Scan turns off the first switch T1 and the second switch T2, so the third switch T3 is thus turned off, and the fourth switch T4 is not electrically connected to the data signal Data again. However, the fourth switch T4 still outputs the pixel current Ioled so that the OLED 42 emits the corresponding luminance because the energy-storage element C is stably kept at the data voltage Vdata.

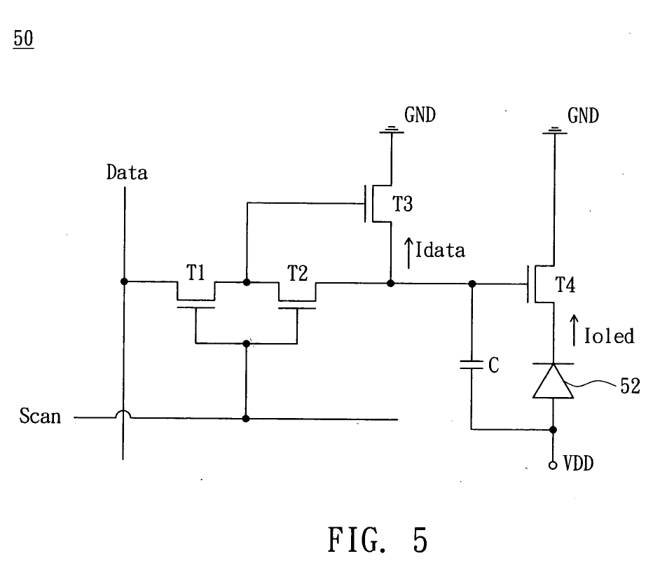

In the AMOLED pixel unit 40, the position of the energy-storage element C is not limited to that for enabling the first terminal of the energy-storage element C to be coupled to the control terminal of the fourth switch T4, and the second terminal of the energy-storage element C to receive the ground voltage GND. FIG. 5 is a circuit diagram showing an AMOLED pixel unit 50 according to a fourth embodiment of the invention. In the AMOLED pixel unit 50, the first terminal of the energy-storage element C is coupled to the control terminal of the fourth switch T4, and the second terminal of the energy-storage element C receives the operation voltage VDD. Consequently, the energy-storage element C may also be stably kept at the data voltage Vdata so that the fourth switch T4 still outputs the pixel current Ioled to the OLED 52 to enable the OLED 52 to emit the corresponding luminance. The circuit architecture and operating principle of other portions are the same as those of FIG. 4, so detailed descriptions thereof will be omitted.

The AMOLED pixel units according to the embodiments of the invention have the current mirror circuit architecture for driving the OLEDs to emit the corresponding luminance and stably keep the luminance in the displaying timing stage.

While the invention has been described by way of examples and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An active matrix organic light emitting diode (AMOLED) pixel unit, comprising:
an organic light emitting diode (OLED) having a cathode for receiving a ground voltage;
a first switch having a first terminal for receiving a data signal, and a control terminal for receiving a scan signal;
a second switch having a first terminal coupled to a second terminal of the first switch, and a control terminal for receiving the scan signal;
a third switch having a first terminal coupled to the second terminal of the first switch, a second terminal for receiving an operation voltage, and a control terminal coupled to a second terminal of the second switch;
a fourth switch having a first terminal coupled to an anode of the OLED, a second terminal for receiving the operation voltage, and a control terminal coupled to the control terminal of the third switch; and
an energy-storage element having a first terminal coupled to the control terminal of the fourth switch, and a second terminal for receiving the operation voltage or the ground voltage.

2. The AMOLED pixel unit according to claim 1, wherein the energy-storage element is a capacitor, and the first switch, the second switch, the third switch and the fourth switch are PMOS transistors.

3. An active matrix organic light emitting diode (AMOLED) pixel unit, comprising:
an organic light emitting diode (OLED) having an anode for receiving an operation voltage;
a first switch having a first terminal for receiving a data signal, and a control terminal for receiving a scan signal;
a second switch having a first terminal coupled to a second terminal of the first switch, and a control terminal for receiving the scan signal;
a third switch having a first terminal coupled to a second terminal of the second switch, a second terminal for receiving a ground voltage, and a control terminal coupled to the second terminal of the first switch;
a fourth switch having a first terminal coupled to a cathode of the OLED, a second terminal for receiving the ground voltage, and a control terminal coupled to the second terminal of the second switch; and
an energy-storage element having a first terminal coupled to the control terminal of the fourth switch, and a second terminal for receiving the operation voltage or the ground voltage.

4. The AMOLED pixel unit according to claim 3, wherein the energy-storage element is a capacitor, and the first switch, the second switch, the third switch and the fourth switch are NMOS transistors.
